(19) United States
(12) Patent Application Publication
(10) Pub. No.: US 2007/0243516 A1
(43) Pub. Date: Oct. 18, 2007

(54) Nonverbal Assessment Instruction Providing System and Method

(75) Inventors: Jack Naglieri, Centreville, VA (US); Kimberly A. Brunnert, San Antonio, TX (US)

Correspondence Address: JACQUELINE E. HARTT, PH.D;ALLEN, DYER, DOPPELT, MILBRATH & GILCHRIST, P.A., P.O. BOX 3791, ORLANDO, FL, 32802-3791, US

(73) Assignee: HARCOURT ASSESSMENT, INC., San Antonio, TX (US)

(21) Appl. No.: 11/673,107

(22) Filed: Feb. 9, 2007

Related U.S. Application Data
(63) Continuation-in-part of application No. 11/179,346, filed on Jul. 12, 2005.
(60) Provisional application No. 60/598,769, filed on Aug. 3, 2004.

(51) Int. Cl. G09B 3/00

(52) U.S. Cl. 434/333

(57) ABSTRACT

A method for providing instructions to a student includes presenting a model assessment item to a student. The student is also presented with a series of pictures. At least some of the pictures in the series represent steps in a thought process of the depicted student used to deduce an answer to the model assessment item. An assessment intended for substantially completely nonverbal administration includes a model assessment item for presentation to a student. The assessment includes a series of pictures for presentation to the student. At least some of the pictures in the series represent steps in a nonverbal sequence of instructions for answering the model assessment item. The model assessment item is depicted in the pictures, and at least some of the pictures in the series represent steps in a thought process of the depicted student used to deduce an answer to the model assessment item.

### CROSS-REFERENCE TO RELATED APPLICATION

This application is a continuation-in-part of application Ser. No. 11/179,346, filed Jul. 12, 2005, which itself claimed priority to provisional application Ser. No. 60/598,769, filed Aug. 2, 2004.

### BACKGROUND OF THE INVENTION

1. Field of the Invention

The present invention relates to assessment systems and methods, and, more particularly, to such systems and methods that are useful for communicating instructions to an examinee, for example, who may speak and understand a language different from that of an examiner or from that of the locale in which the assessment is given.

2. Description of Related Art

When assessments are administered to an examinee, for example, a child who cannot yet read, instructions are typically demonstrated or mimed along with verbalization by an examiner/administrator. Such instructions are recommended to be given using standardized words, movements, and/or tasks in order to guarantee uniformity of administration. A problem arises, however, if the examiner and the examinee do not speak the same language, or if the examinee is deaf or hard of hearing.

Cross-linguistic communication tools are known in the art for use, for example, by travelers. A grid system is known that includes symbols representing objects and common phrases in two languages. A communication aid comprising a plurality of cards, each depicting a basic need, has also been taught, in addition to a flip chart having side-by-side sectors, each containing words in two languages, and at least one of the sectors containing pictures of common elements, permitting a person to be understood by forming a sentence with the sectors turned to a desired object.

### SUMMARY OF THE INVENTION

An aspect of the present invention is directed to a method for providing instructions to an examinee. The method comprises the step of presenting an assessment item to an examinee. An example of such an assessment item might comprise a nonverbal plurality of symbols.

An additional aspect of the present invention is directed to a cross-linguistic communication tool. Because of the independence from language, the present invention is more universal and more useful than other known cross-linguistic communication tools.

In a first embodiment, a first series of pictures is presented to the examinee. Each picture in the first series represents a step in a nonverbal sequence of instructions from a depicted examiner to a depicted examinee for answering the assessment item. Next a second series of pictures is presented to the examinee. Each picture in the second series represents a step in the depicted examinee's thought process used to deduce an answer to the assessment item.

In a second embodiment, a method for providing instructions to an examinee also comprises the step of presenting a first assessment item to an examinee. Also presented to the examinee is a series of pictures. At least some of the pictures in the series represent steps in a nonverbal sequence of instructions from a depicted examiner to a depicted examinee for answering a second assessment item that is analogous to the first assessment item. In addition, at least some of the pictures in the series represent steps in a thought process of the depicted examinee used to deduce an answer to the first assessment item.

In these embodiments, a nonverbal set of instructions can be given to the examinee in an easily understandable pictorial form with demonstration and/or verbalization by the examiner only if deemed necessary, as required by the situation.

In a third embodiment, provided for use, for example, without the aid of an examiner, a method for providing instructions to a student includes presenting a model assessment item to a student. The student is also presented with a series of pictures. At least some of the pictures in the series represent steps in a thought process of the depicted student used to deduce an answer to the model assessment item.

An assessment intended for substantially completely nonverbal administration includes a model assessment item for presentation to a student. The assessment includes a series of pictures for presentation to the student. At least some of the pictures in the series represent steps in a nonverbal sequence of instructions for answering the model assessment item. The model assessment item is depicted in the pictures, and at least some of the pictures in the series represent steps in a thought process of the depicted student used to deduce an answer to the model assessment item.

The features that characterize the invention, both as to organization and method of operation, together with further objects and advantages thereof, will be better understood from the following description used in conjunction with the accompanying drawing. It is to be expressly understood that the drawing is for the purpose of illustration and description and is not intended as a definition of the limits of the invention. These and other objects attained, and advantages offered, by the present invention will become more fully apparent as the description that now follows is read in conjunction with the accompanying drawing.

### BRIEF DESCRIPTION OF THE DRAWINGS

FIG. 1 is an exemplary first set of pictures usable in a first embodiment of the invention.

FIG. 2 is an exemplary second set of pictures for the first embodiment.

FIG. 3 is an exemplary series of pictures usable in a second embodiment of the invention.

FIG. 4 is an exemplary stimulus page to be shown to an examinee.

FIGS. 5A and 5B illustrate a coding subtest, wherein an examiner is pointing out the code (FIG. 5A) and the examinee is carrying out the coding (FIG. 5B).

FIG. 6 is an exemplary stimulus page to be given to the examinee.

FIG. 7 is an exemplary first set of pictures usable in a third embodiment of the invention.

### DETAILED DESCRIPTION OF THE PREFERRED EMBODIMENTS

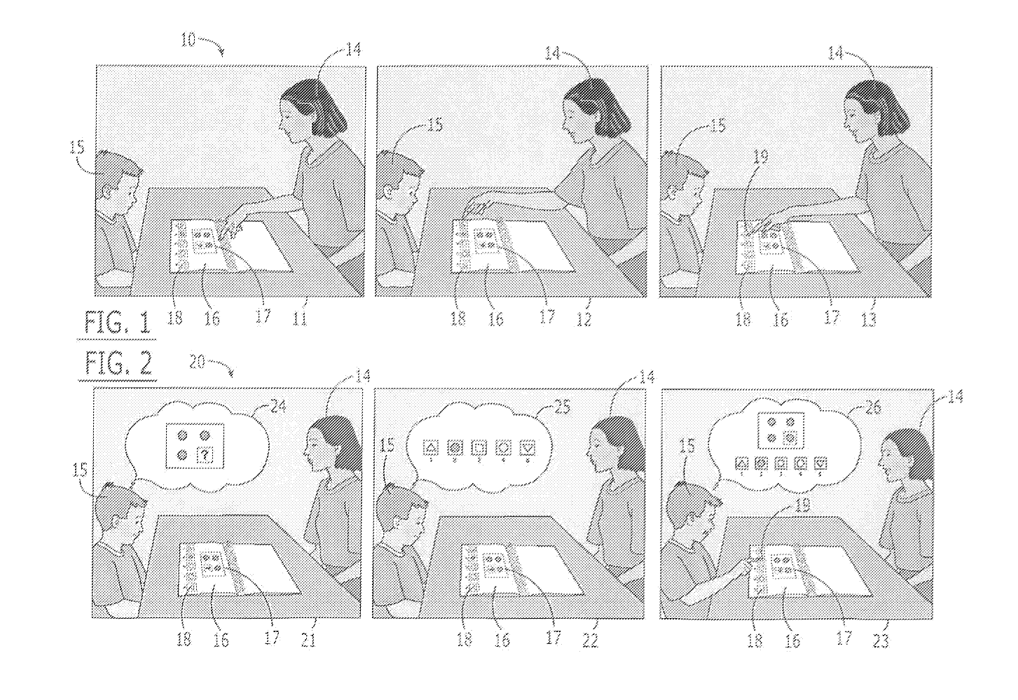

A description of the preferred embodiments of the present invention will now be presented with reference to FIGS. 1-7.

A first embodiment of a method for providing instructions to an examinee is depicted in FIGS. 1 and 2. This aspect of the method comprises the step of presenting an assessment item to an examinee. An example of such an assessment item might comprise a nonverbal plurality of symbols from among which the examinee is to select one that meets the objective of the assessment item, although such an assessment is not intended to be limiting. Such items are well known in the art for measuring an examinee's ability to perform abstract reasoning, and may include finding an object that belongs with a group of other analogously shaped objects.

A first series of pictures 10 is presented to the examinee, such as the series of “cartoons” comprising FIG. 1, substantially simultaneously with the item. Each picture 11-13 in the first series 10 represents a step in a nonverbal sequence of instructions from a depicted examiner 14 to a depicted examinee 15 for answering the same type of assessment item 16 as that presented to the examinee. In the first picture 11, the depicted examiner 14 is pointing to the query portion 17 of the item 16, which here comprises three objects and one blank with a question mark. The depicted examiner 14 in the second picture 12 next points to a row 18 of five possible answers given for the item query 17. In the third picture 13 the depicted examiner 14 points to the correct answer 19, thus illustrating the steps to be used in answering the item query 17.

Next a second series 20 of pictures 21-23 is presented to the examinee (FIG. 2). Each picture 21-23 in the second series 20 represents a step in the depicted examinee's 15 thought process used to deduce an answer to the query portion 17 of the assessment item 16, here shown in cartoon-type “thought bubbles” 24-26. In the first picture 21 the depicted examinee 15 is looking at and assimilating 24 the item query 17. In the second picture 22 the depicted examinee 15 is looking at and assimilating 25 the set of possible answers 18. In the third picture 23 the depicted examinee 15 is mentally 26 and physically identifying the correct answer 19.

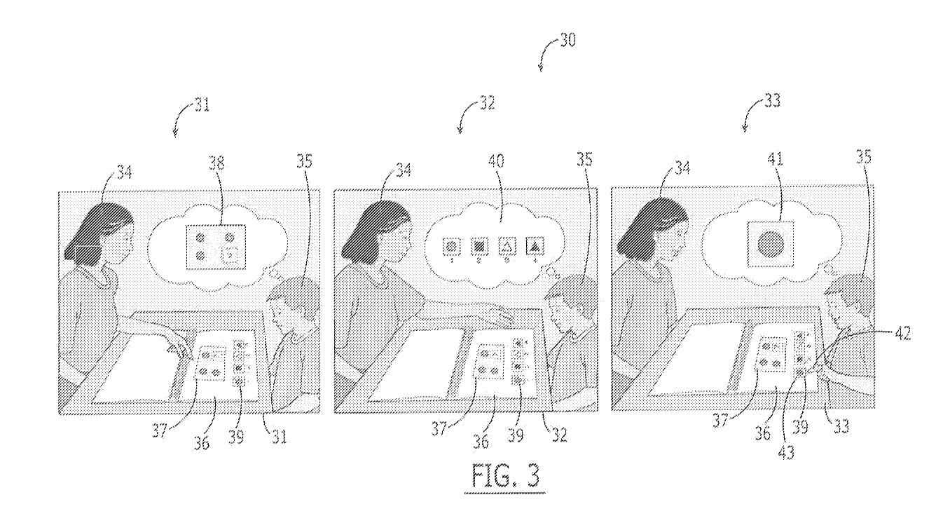

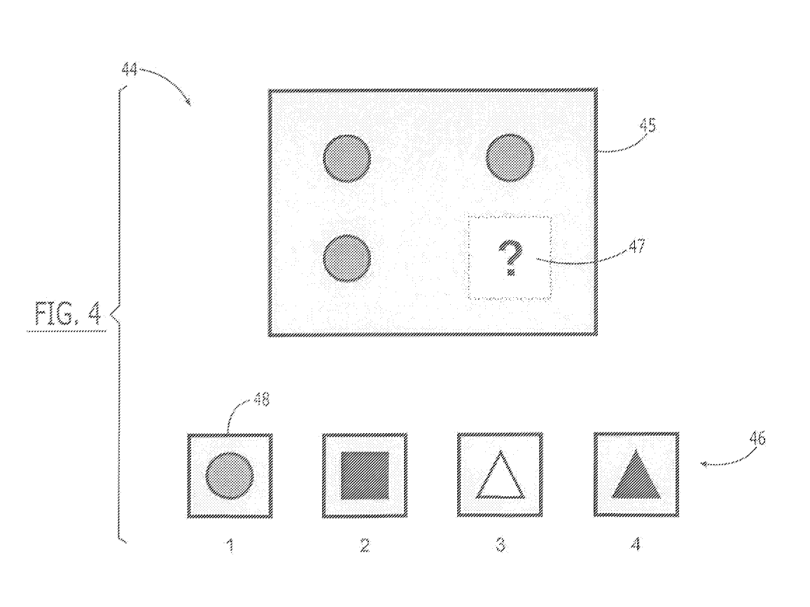

A second embodiment is depicted in FIG. 3. In this embodiment, a series of pictures 30 is presented to the examinee, here shown to include “cartoons” 31-33. Each picture 31-33 represents a step in a nonverbal sequence of instructions from a depicted examiner 34 to a depicted examinee 35 for answering the same type of assessment item 36 as that presented to the examinee. The purpose of the pictorial directions is to provide a standardized method of nonverbally communicating to the examinee what he or she is expected to do. The pictorial directions typically depict an examiner presenting or performing the item, with an examinee thinking about the item, and finishing with the examinee correctly answering or doing the item.

In an embodiment, the directions are given first and are substantially invariable. The directions include a series of gestures that accompany the presentation of the pictorial directions. These gestures may be doing what is pictured. The pictorial directions and the examiner's actions are preferably carefully coordinated to maximize the examinee's understanding of the correspondence between the materials and the task.

An example of a picture series 30 for a demonstration item is given in FIG. 3, for an exemplary subtest for matrices. The examiner points to the top of the stimulus page, drawing the examinee's attention to the pictorial directions and the stimulus materials, and, at times, to demonstrate the task itself. Some subtest directions may include the use of simple spoken sentences.

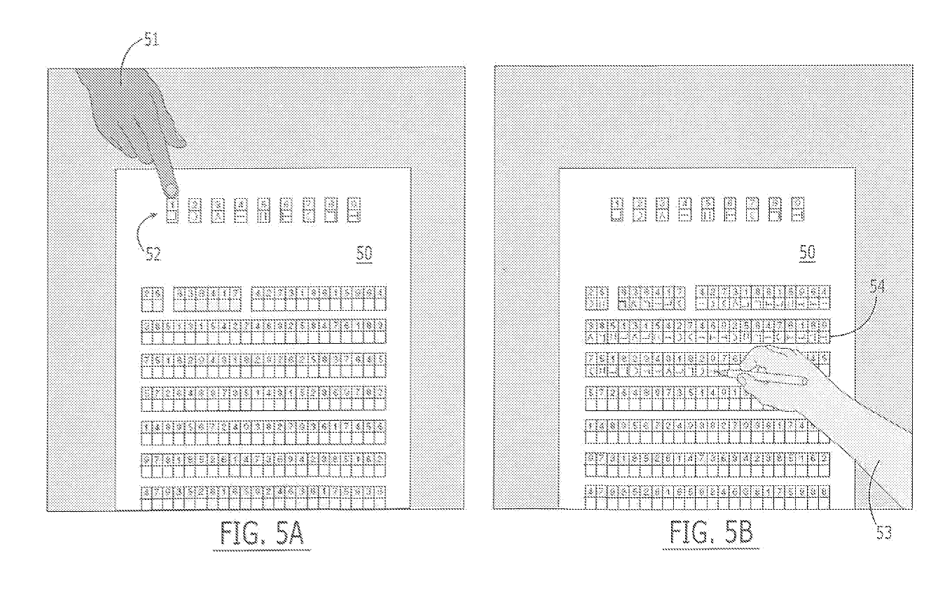

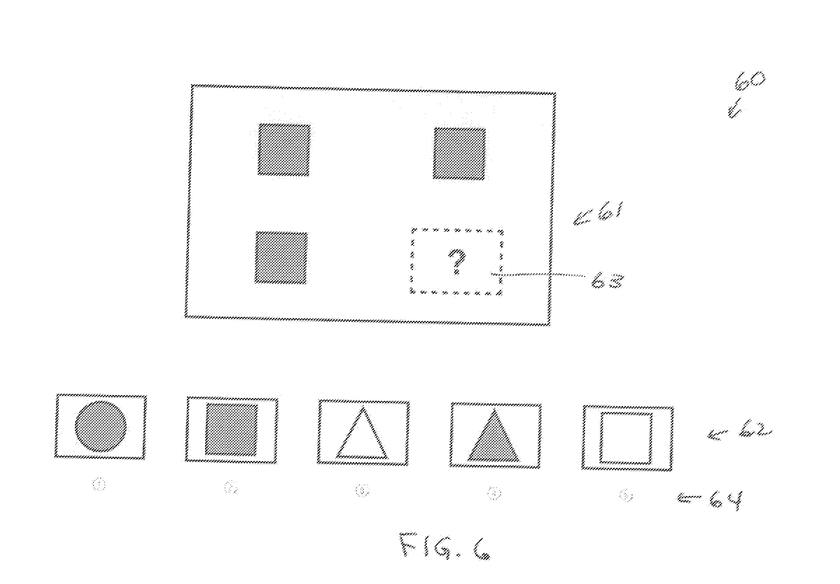

The examiner is directed to place a stimulus book containing pictorial directions (e.g., FIG. 3) and item (e.g., FIG. 4) toward the examinee. In this example, which includes a demonstration item, both of these figures would be in view of the examinee simultaneously, with the item 44 of FIG. 4 on top of the page. In an administration of a subtest, a separate response booklet may be provided that contains the items 50 as in FIGS. 5A and 5B, wherein an examiner 51 is demonstrating the code 52 (FIG. 5A) and an examinee 53 is carrying out the coding steps 54.

To begin, the examiner is to slowly point to each frame of the pictorial directions from the examinee's left to right, briefly looking at the examinee as he/she points to each frame to be sure the examinee is attending. The examinee is allowed time to look at the pictorial directions, up to 1 minute if needed. The examiner points to the first frame 31, wherein the depicted examiner 34 is pointing to the query portion 37 of the item 36, which here comprises three objects and one blank with a question mark. The examinee is shown creating a mental picture 38 of the query portion 37. Then the examiner is to point to the top of the stimulus page 44, containing the item stem 45 (FIG. 4).

Next the examiner points to the second frame 32, wherein the depicted examinee 35 has created a mental picture 40 of the set of possible answers 39 of the item 36 to which the depicted examiner 34 is pointing. Also in the second frame 32, the depicted examiner 34 is pointing to a row 39 of four possible answers given for the item query 37. Then the examiner slowly sweeps his/her hand along the response options 46 of the item 44.

The examiner then points to the third frame 33 of the pictorial directions 30, wherein the depicted examinee 35 is mentally 41 and physically 42 identifying the correct answer 43. The examiner points to the question mark 47 in the matrix 45, slowly sweeps his/her hand along the response options 46, and looks at the examinee.

Thus in this embodiment 30 each set of pictorial directions is demonstrated as it is being presented to the examinee. If the examinee has not understood the directions, does not answer, or appears confused, the examiner gives the examinee clues to solve the sample items. The clues can be either additional gesturing (e.g., pointing to parts of the item), or can involve verbalization such as simple words, phrases, or clauses, which will be provided to the examiner. For example, the examiner might say “Which one of these [pointing to the response options 46 in a sweeping motion from the examinee's left to right] goes here?” This sentence is supplied in a plurality of languages. Additional help, verbal or nonverbal, may be provided if needed.

If a correct response is given, the examiner should communicate approval nonverbally or verbally. If an incorrect or no response is given, the examiner should point to the three shapes in the matrix 45 and the point to the question mark 47. The examiner sweeps his/her hand along from option 1 to option 4 of the response options 46 and say, “This one is the answer,” pointing to the correct answer 48. Additional help may be provided if needed.

The test is scored by counting the number of correct responses made by the examinee. This number is then compared with normed values to provide an ability score.

In alternate embodiments, an electronic version of the series of pictures is presented to the examinee. Such apparatus as a touch screen (or other input devices known in the art) can be used for presenting the series of pictures and for receiving the examinee's answers, or personal data assistants with a touch screen, may also been envisioned, as well as a video or DVD option for presenting the nonverbal demonstration and the picture series. In this case, actors could be employed to provide the demonstration.

Thus a completely nonverbal set of instructions can be given to the examinee in an easily understandable pictorial form, although typically some basic oral instructions can accompany the pictures. The present invention is successful in the elimination of misclassification of students as disabled when in fact there is a language barrier present. In addition, miming can be provided by the examiner if deemed necessary. Some standardized words may also be added if desired.

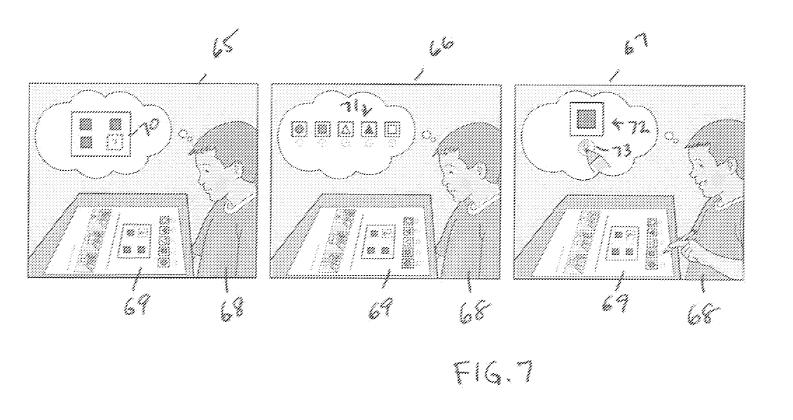

In yet another embodiment of the invention, a method and assessment are provided for delivering instructions to a student (FIGS. 6 and 7). In this embodiment, a model assessment item 60 (FIG. 6) is provided for presentation to a student. The model assessment item 60, as above, includes an item stem 61 and a set 62 of possible answers, here, five possible answers. Again, within the item stem 61 is a blank space with a question mark 63 indicating the missing element to be deduced by the student. Here, since this embodiment is intended for student use without a one-on-one examiner, there are also provided answer bubbles 64 beneath each of the possible answers 62.

A series of pictures 65-67 (FIG. 7) is also provided for presentation to the student. At least some of the pictures in the series represent steps in a thought process of the depicted student 68 used to deduce an answer to the same model assessment item 69 depicted in the series of pictures 65-67.

The first picture 65 illustrates the student looking at and thinking about the item stem 70; the second 66, looking at and thinking about the possible answers 71. The third picture 67 shows the student picking a response 72 and filling in an answer bubble 73.

Then, subsequently, the student should be able to proceed with the remainder of the assessment, having learned how to take the assessment from the pictorial directions 65-67.

As above, some simple oral directions may be provided, but basically the assessment in this embodiment is intended for administration without a one-on-one examiner providing instructions or marking an answer sheet.

In the foregoing description, certain terms have been used for brevity, clarity, and understanding, but no unnecessary limitations are to be implied therefrom beyond the requirements of the prior art, because such words are used for description purposes herein and are intended to be broadly construed. Moreover, the embodiments of the apparatus illustrated and described herein are by way of example, and the scope of the invention is not limited to the exact details of construction.

What is claimed is:

1. A method for providing instructions to a student comprising the steps of:
presenting a model assessment item to a student; and
presenting a series of pictures to the student, at least some of the pictures in the series representing steps in a thought process of the depicted student used to deduce an answer to the model assessment item.

2. The method recited in claim 1, wherein the model assessment item comprises an item stem and a plurality of response options, and the thought process steps represented comprise the depicted student thinking about the item stem, the response options, and a correct answer selected from the response options.

3. The method recited in claim 2, wherein at least one of the pictures in the series represents the depicted student performing a physical action in concert with the answer deducing step.

4. An assessment intended for substantially completely nonverbal administration comprising:
a model assessment item for presentation to a student; and
a series of pictures for presentation to the student, at least some of the pictures in the series representing steps in a nonverbal sequence of instructions for answering the model assessment item, the model assessment item depicted in the pictures, and at least some of the pictures in the series representing steps in a thought process of the depicted student used to deduce an answer to the model assessment item.

5. The assessment recited in claim 4, wherein the model assessment item comprises an item stem and a plurality of response options, and the thought process steps represented comprise the depicted student thinking about the item stem, the response options, and a correct answer selected from the response options.

6. The assessment recited in claim 5, wherein at least one of the pictures in the series represents the depicted student performing a physical action in concert with the answer deducing step.
